(19) United States
(12) Patent Application Publication
(10) Pub. No.: US 2008/0310901 A1
(43) Pub. Date: Dec. 18, 2008

(54) METHOD OF ISSUING A PRINTED TICKET

(75) Inventor: Philippe MICHON, Clamart (FR)

Correspondence Address: Muncy, Geissler, Olds & Lowe, PLLC, P.O. BOX 1364, FAIRFAX, VA, 22038-1364, US

(73) Assignee: AXIOHM

(21) Appl. No.: 12/138,961

(22) Filed: Jun. 13, 2008

(30) Foreign Application Priority Data
Jun. 15, 2007 (FR) 07 04262

(51) Int. Cl. B41J 13/10; B41L 45/00

(52) U.S. Cl. 400/605; 101/66

(57) ABSTRACT

The present invention relates to a method of issuing a printed ticket coming from a thermal printer, which printer comprises in a structure, a print head and a capstan for driving the ticket, a ticket travel guide being provided in the structure downstream from the print members, the method consisting in:
a) storing in a memory of the printer the data for printing on the ticket;
b) causing the ticket to advance by a determined amount so as to enable the user to grasp the ticket manually at the end of the guide;
c) within a determined length of time from the end of step b), detecting the user applying a traction force to the ticket; and
d) in response to said detection, simultaneously causing printing to take place on the ticket and the ticket to be ejected towards the user.

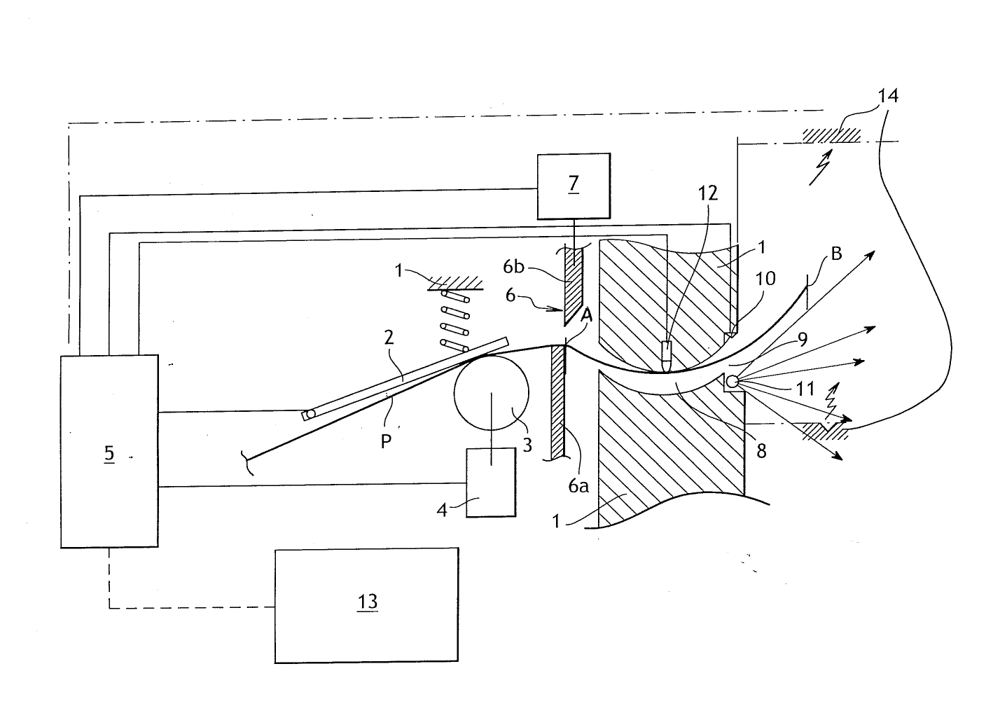

The present invention relates to issuing tickets, receipts, . . . constituting a printed summary of some particular transaction such as a purchase, an access authorization, . . . , in the form of an invoice, an entry ticket, . . . .

### BACKGROUND OF THE INVENTION

It is an extremely widespread practice for devices that record a payment to print out a receipt or an invoice for the transaction in question. The receipt is handed over to the user by a clerk or other person performing this function.

The present trend is to eliminate human intervention completely from this field. This applies for example in numerous fuel stations where the ticket is issued to the user via an ejector after it has been printed and stored in the machine for long enough to enable printing to be completed.

It quite often happens that the user fails to take the ticket, either by forgetting it, or else deliberately, and thus that the ticket is printed pointlessly, thereby uselessly consuming paper, polluting the environment in the machine, and accelerating aging of the members of the printer machine, leading to increased cost and maintenance requirements.

To mitigate this drawback, certain devices are provides with a control to ensue that the ticket is printed at the request of the user, after which the printed ticket is ejected. The means implemented for performing this improvement nevertheless increase the cost of the device and add further to its maintenance requirements, particularly since any member that is functionally handled by a user is inevitably damaged. Finally, the printing that results from the user manifesting a desire for the ticket takes place after a certain amount of time, with the ticket being issued via an ejector only at the end of that time. During this time, the user can forget it, and attend to other preoccupations in the meanwhile. That leads to an audible or visible warning being incorporated, which is put into operation at the end of printing, thereby further increasing the complexity of the device.

The performance of thermal printers is continuously improving, in particular in terms of printing speed and of the time required to cut tickets from a roll of paper.

### OBJECT OF THE INVENTION

The invention seeks to provide a different solution to the question of pointlessly printing tickets or coupons, which solution, by making best use of modern high performance printers, makes it possible to avoid leaving any initiative to the user other than that of taking hold of the ticket that is for the user. The device therefore does not suffer from damage due to misuse, nor does it suffer from any increase in the cost of maintenance operations. The means of the invention are also minimal in hardware terms, with the printer being controlled by software in response to detecting or failing to detect an event that results from the user manifesting the desire to take possession of the ticket.

### SUMMARY OF THE INVENTION

In a first aspect, the invention thus provides a method of issuing a printed ticket coming from a thermal printer, which printer comprises in a structure, a print head and a capstan for driving the ticket, a ticket travel guide being provided in the structure downstream from the print members, which method consists in:

a) storing in a memory of the printer the data for printing on the ticket;

b) causing the ticket to advance by a determined amount so as to enable the user to grasp the ticket manually at the end of the guide;

c) within a determined length of time from the end of step b), detecting an event that is directly representative of the user manifesting the desire to take possession of the ticket; and

d) in response to said detection, simultaneously causing printing to take place on the ticket and the ticket to be ejected towards the user.

By means of this succession of steps, the method of the invention presents the advantage of avoiding any useless or unused printing. Printing is performed simultaneously with the user extracting the ticket; there is no wait between the user manifesting the desire to obtain a ticket and the user actually obtaining that ticket. Thus, the user cannot manifest a desire for a ticket and then forget to take it.

The event in question may be of various kinds, for example:

taking hold of the end of the ticket, thereby creating tension in the portion of the ticket located downstream from the printer;

taking hold of the end ticket, thereby causing the tape to move downstream, giving rise to rotation of the capstan which is detected by the electronic card of the printer controller;

the presence of the hand of the user in the immediate vicinity of the graspable portion of the ticket, which presence can be detected by a detector dedicated to this purpose;

. . . .

In order to save paper, if the device does not detect the user grasping the ticket within a determined period, the ticket is retraced back into the inside of the machine so that the unused paper lying between the print head and the grasping zone is not lost.

The invention relates mainly to tickets that are separated by cutting off a printed segment from the end of a continuous tape. It can also be applied to precut tickets.

In a second aspect, the invention provides a printer enabling the above method to be implemented. The printer comprises a structure carrying a print head co-operating with a motor-driven capstan and defining downstream therefrom a travel guide for the ticket, such that the guide opens out to the outside of the structure via an opening fitted with a paper-presence detector and the printer includes a detector for detecting the above-mentioned event.

Given the increase in the performance of modern thermal printers, in particular in terms of printing speed, there is no longer any need to implement an ejector that is separated from the print head by a buffer space for storing the ticket while it is being printed. This disposition significantly simplifies the installation which becomes much more compact, and also simplifies the members and the control programs implementing the method.

Other characteristics and advantages of the invention appear from the description given below of an embodiment thereof.

### BRIEF DESCRIPTION OF THE DRAWING

Reference is made to the accompanying drawing in which the sole FIGURE is a diagram of a printer in accordance with the invention for implementing the method of the invention.

### DETAILED DESCRIPTION OF THE INVENTION

With reference to the FIGURE, it can be seen that the invention comprises a structure 1 represented highly diagrammatically and having connected thereto in conventional manner firstly a print head 2 and secondly a capstan 3 for driving a tape P of print medium for printing under the head 2, the capstan being connected to a drive motor 4. A print controller 5 controls the operation of the print head 2 and of the capstan 3 and causes them to operate synchronously.

The device of the invention also comprises cutter members 6 for detaching a printed ticket from a tape of medium, in general thermal paper, the cutter means comprising a stationary portion 6a and a moving portion 6b, which moving portion is connected to an actuator 7. These members 6 are represented diagrammatically in the FIGURE as being in the form of a guillotine. There are numerous other ways in which cutter members can be made for implementing this function. The actuator 7 is likewise controlled by the controller 5.

Downstream from the cutter member 6, the structure 1 defines a guide 8 for guiding the travel of the paper P and opening to the outside of the device via an opening in the form of a slot 9. In this slot 9, the structure includes a paper-presence detector 10 having its output connected to the controller 5. It also presents a light-emitter device 11 that can be activated when the paper has gone out through the slot 9 in a state ready to be taken hold of by a user.

In the guide 8, the structure includes a sensor 12 for sensing the tension exerted on the paper, this detector also being connected to the controller 5.

Finally, the controller 5 is in communication with a microprocessor 13 from which it processes data for printing on the paper tape by means of the print head 2 and the capstan 3.

The operation of the above-described device takes place as follows.

Before a stage of printing the ticket that is to be printed, the free end of the paper tape is situated at a point A in the FIGURE. The controller 5 receives from the microprocessor 13 all of the data that is to be printed on the tape in order to make a ticket. It stores the data in a suitable memory and simultaneously causes the capstan 3 to be driven in such a manner that the free edge of the paper tape situated at point A is moved to a point B situated outside the device, beyond the slot 9.

Simultaneously, and where appropriate, it causes non-personalized characters to be printed on the ticket that are independent of the data received from the microprocessor, thus enabling the ticket to carry recognition signs such as a logo, a trademark, or an advertisement, which signs are common to all of the tickets.

The users takes hold of the ticket via the end that reaches the point B, thereby establishing tension in the tape, which is sensed by the sensor 12, e.g. by the paper coming into contact therewith. The signal issued by the sensor 12 is interpreted by the controller 5 as an order to print the data it is holding in memory onto the tape. The speed of printing is sufficient for the user to have the impression of pulling out the ticket under his or her own action.

In a first variant (not shown) of the printer of the invention, instead of the sensor 12, the controller 5 includes means enabling rotation of the capstan 3 to be detected by the motor 4. This detection instantly causes the order to be generated to print on the ticket and causes the ticket to be delivered as described above.

In a second variant, the sensor 12 is replaced by a detector 14 for detecting the presence of the user's hand (which detector may be a heat detector, a proximity detector, a photoelectric cell, . . . ). On being transmitted to the controller 5, the signal output by this detector causes printing to take place immediately on the ticket.

Once printing has terminated, the controller causes a segment of tape to be cut off by the cutter 6a, which segment then becomes a ticket in the hand of the user. The device is then again ready for use in printing a following ticket.

Consideration is given below to circumstances in which the ticket reaches a point B but no traction is exerted thereon by the user. The sensor 12 thus remains silent so far as the controller 5 is concerned, and the controller measures a time-out period, at the end of which it deletes the data that was previously placed in its memory. Simultaneously, it causes the motor 4 of the capstan 3 to turn in the direction opposite to the printing direction in order to retract the ticket so that its free edge goes from point B to point A in the FIGURE. The controller 5 remembers that it has already printed signs on the ticket, and on the next print operation, it does not repeat this stage of printing signs at the same time as it moves the front edge from point A to point B.

It can thus readily be understood that tickets are printed and issued only when appropriate, i.e. only when a user clearly manifests the intention to obtain the ticket by taking hold of it.

What is claimed is:

1. A method of issuing a printed ticket coming from a thermal printer, which printer comprises in a structure, a print head and a capstan for driving the ticket, a ticket travel guide being provided in the structure downstream from the print members, the method consisting in:
a) storing in a memory of the printer the data for printing on the ticket;
b) causing the ticket to advance by a determined amount so as to enable the user to grasp the ticket manually at the end of the guide;
c) within a determined length of time from the end of step b), detecting an event that is directly representative of the user manifesting the desire to take possession of the ticket; and
d) in response to said,detection, simultaneously causing printing to take place on the ticket and the ticket to be ejected towards the user.

2. A method according to claim 1, wherein, in the absence of the above-mentioned event being detected by the end of said period, the method consists in:
e) causing the ticket to be retracted into the inside of the printer through a distance BA that is substantially equal to the above-mentioned determined distance AB.

3. A method according to claim 1 for issuing tickets that are separated from a continuous tape by a cutter member situated downstream from the thermal printer, the method, after step d), includes the following step:
f) cutting off the printed ticket grasped by the user.

4. A method according to claim 1, wherein, during step b), it includes the following step:
g) printing on the ticket systematic information that is common to all of the tickets issued.

5. A method according to claim 1, wherein the above-mentioned event is the user generating a traction force on the ticket.

6. A method according to claim 1, wherein said event is the capstan of the printer beginning to turn.

7. A method according to claim 1, wherein said event is the presence of the hand of the user in the immediate vicinity of the graspable end of the ticket.

8. A thermal printer for implementing the method of claim 5, the printer comprising a structure carrying a print head co-operating with a motor-driven capstan, the head being controlled by a controller, the structure defining downstream from said members a travel guide for the ticket, wherein the guide opens out to the outside of the structure via an opening fitted with a ticket-presence detector, and wherein the structure includes on the path of the ticket a sensor for sensing the tension state thereof and connected to the controller of the print head.

9. A printer for implementing the method according to claim 6, the printer comprising a structure carrying a print head controlled by a controller and co-operating with a motor-driven capstan, the structure defining downstream from these members a travel guide for the ticket, wherein the guide opens out to the outside of the, structure via an opening fitted with a ticket-presence detector, and wherein the motor constitutes a detector for sensing rotation of the capstan as generated by the user applying traction to the ticket, and is connected to the print head controller.

10. A printer for implementing the method according to claim 7, the printer comprising a structure carrying a print head controlled by a controller and co-operating with a motor-driven capstan, the structure defining downstream from these members a travel guide for the ticket, wherein the guide opens to the outside of the structure via an opening fitted with a ticket-presence detector, and wherein the structure includes at the outlet to the outside of the guide a detector for detecting the presence of the hand of a user and connected to the controller of the print head.
